(19) United States
(12) Patent Application Publication
(10) Pub. No.: US 2024/0104828 A1
(43) Pub. Date: Mar. 28, 2024

(54) Animatable Neural Radiance Fields from Monocular RGB-D Inputs

(71) Applicant: Meta Platforms Technologies, LLC, Menlo Park, CA (US)

(72) Inventors: Tiantian Wang, Merced, CA (US); Nikolaos Sarafianos, Sausalito, CA (US); Tony Tung, San Francisco, CA (US)

(21) Appl. No.: 17/976,583

(22) Filed: Oct. 28, 2022

(30) Foreign Application Priority Data
Sep. 21, 2022 (GR) 20220100770

(51) Int. Cl. G06T 15/20; G06T 13/40

(52) U.S. Cl. CPC G06T 15/20; G06T 13/40

(57) ABSTRACT

In particular embodiments, a computing system may access a particular image frame and corresponding depth information of a dynamic scene. The depth information is used to generate a point cloud of the particular image frame. The system may generate a first latent representation based on the point cloud. The system may access a sequence of image frames of the dynamic scene and a set of key frames. The system may generate, using a temporal transformer, a second latent representation based on tracking and combining temporal relationship between the sequence of image frames and the set of key frames. The system may access camera parameters for rendering the one or more objects from a desired novel viewpoint and generate a third latent representation. The system may train an improved neural radiance fields (NeRF) based model for free-viewpoint rendering of the dynamic scene based on the first, second, and third latent representations.

### PRIORITY

This application claims the benefit, under 35 U.S.C. § 119(b), of Greek Application No. 20220100770, filed 21 Sep. 2022, which is incorporated herein by reference.

### TECHNICAL FIELD

This disclosure generally relates to novel view and unseen pose synthesis. In particular, the disclosure relates to an improved method or technique for free-viewpoint rendering of dynamic scenes under novel views and unseen poses.

### BACKGROUND

Neural radiance field (NeRF) is a technique that enables novel-view synthesis or free-viewpoint rendering (i.e., rendering of a visual scene from different views or angles). For example, if a front or a center view of a visual scene is captured using a camera (e.g., a front camera), then NeRF enables to view the objects/elements in the visual scene from different views, such as a side view or from an angle which is different from what the image was captured from. However, most of the current NeRF-based models are limited to novel-view synthesis of static scenes (e.g., a visual scene containing static objects, such as desk, chair, etc.). To represent static scenes, NeRF-based models learn an implicit representation using neural networks, which enables photo-realistic rendering of shape and appearance from images. With dense multi-view observations as input, NeRF encodes density and color as a function of three-dimensional (3D) coordinates and viewing directions by multi-layer perceptrons (MLPs) along with a differentiable renderer to synthesize novel views. While it shows unprecedented visual quality on static scenes, applying it to high quality free-viewpoint rendering of dynamic scenes (e.g., human in motion, dynamic videos, etc.) remains a challenging task.

One example prior work, method, or model that extends NeRF to dynamic scenes is NeuralBody. NeuralBody proposes a set of latent codes shared across all frames anchored to a human body model in order to replay character motions from arbitrary viewpoints under training poses. These methods, where the deformations are learned by neural networks, allow to handle general deformations, and synthesize novel poses by using interpolation in the latent space. However, the human poses cannot be controlled by users and/or the synthesis fails under novel or unseen poses. Stated differently, the prior works, methods, or NeRF-based models fail to render novel views of person with unseen poses (e.g., poses that were not seen during training). Also, human-pose-based representation may model the body shape at any time step but will fail to capture fine-level details or detailed appearance. That is, modeling detailed appearance of objects in a dynamic scene, such as dynamic clothed humans, cloth wrinkles, facial expressions, face details, from videos remains a challenging problem and is not achieved by prior works or methods.

Accordingly, there is a need for an improved method or technique for training a NeRF-based model that can perform novel-view synthesis or free-viewpoint rendering of dynamic scenes with fine-level details and is also able to render novel views of unseen poses (e.g., unseen human poses).

### SUMMARY OF PARTICULAR EMBODIMENTS

Embodiments described herein relate to an improved method or technique for novel view and unseen pose synthesis of a dynamic scene. The dynamic scene may include one or more animatable objects, such as a person in motion (e.g., person walking, baby dancing). The improved method integrates observations across frames and encodes the appearance at each individual frame by utilizing the human pose that models the body shape and point clouds which cover partial part of the human as the input. Specifically, the improved method simultaneously learns a shared set of latent codes anchored to the human pose among frames and learns an appearance-dependent code anchored to incomplete point clouds generated by monocular RGB-D at each frame. The improved method integrates a pose code and an appearance code to synthesize humans in novel views and different poses with high fidelity. The pose code that is anchored to the human pose may help model the human shape (e.g., models the shape of the performer) whereas the appearance code anchored to points clouds may help infer fine-level details and recover any missing parts, especially at unseen poses. To further recover non-visible regions in query frames, a temporal transformer is utilized to integrate features of points in query frames and tracked body points from a set of automatically selected key frames. The improved method achieves significantly better results against the state-of-the-art methods under novel views and poses with quality that has not been observed in prior works. For example, fine-level information or details, such as fingers, logos, cloth wrinkles, and face details are rendered with high fidelity using the NeRF-based model that is trained based on the improved method.

In particular embodiments, training a NeRF-based model using the improved method or technique discussed herein includes generating, at each training iteration, three different codes or latent representations including an appearance code, a pose code, and a view and spatial code. The appearance code encodes appearance information or fine-level details of object(s) in a dynamic scene. For example, if the dynamic scene includes a person in motion, then the appearance code encodes facial characteristics of the person, cloth wrinkles, etc. The appearance code may be generated based on point clouds of a single RGB image and corresponding depth image (herein referred to as a RGB-D image). The pose code encodes pose information of the object(s) (e.g., person) depicted in the dynamic scene. For example, the pose code may encode what the current overall pose or shape of the person looks like from a particular viewpoint as defined by the query point or point of interest. In order to generate the pose code at training time, a window or a sequence of query frames (e.g., 10 RGB-D images) and a set of key frames (e.g., 3 key frames) may be used as input. The key frames are used to fill-in or complete missing details of the person from the particular viewpoint that maybe different from the viewpoint(s) from which the sequence of image frames is captured. A temporal transformer is used to combine information (e.g., temporal relationship) between the query frames and the set of key frames and generate a pose code based on the combined information. The view and spatial code encodes camera pose information that is used to render the dynamic scene from a particular viewpoint. The camera pose information may include a spatial location and a viewing direction.

Once the three codes or latent representations i.e., the appearance code, the pose code, and the view and spatial code are generated, these codes may be feed into a density and color model, which is basically the NeRF, to output a color and a density value for each pixel of an image to be rendered from a specific viewpoint (e.g., desired novel viewpoint). The generated color and density values are then compared with color and density values of a ground-truth image and the NeRF-based Model is updated based on the comparison. Once the NeRF-based model is sufficiently trained using the improved method discussed herein (e.g., model is trained based on several iterations or different camera viewpoints), the trained model may be used to perform novel view and unseen pose synthesis of a particular dynamic scene at inference or test time.

Some of the notable features associated with the improved method or technique for novel view and unseen pose synthesis are, for example and not by way of limitation, as follows: (1) a new framework is introduced with monocular RGB-D as input, (2) significant improvement is observed on the unseen poses compared to existing methods, with high-fidelity reconstruction of fine-level details (e.g., face details, cloth wrinkles, body details, logos, etc.) at a resolution and fidelity, which the prior works (e.g., NeuralBody) was not able to achieve, (3) pose and appearance representations are combined by modeling shared information across frames and specific information at each individual frame. These two representations help the NeRF-based Model to generalize better to novel poses compared to only utilizing the pose representation, (4) a temporal transformer is used to combine information across frames, which helps to recover non-visible details in the query frame, especially at unseen poses or views, and (5) the improved technique is extensively evaluated against state-of-the-art techniques on several sequences of humans in motion and exhibits significantly higher rendering quality of novel view and novel pose synthesis.

The embodiments disclosed herein are only examples, and the scope of this disclosure is not limited to them. Particular embodiments may include all, some, or none of the components, elements, features, functions, operations, or steps of the embodiments disclosed herein. Embodiments according to the invention are in particular disclosed in the attached claims directed to a method, a storage medium, a system, and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 illustrates an overall training process for training an improved NeRF-based model for novel view and unseen pose synthesis of dynamic scenes, in accordance with particular embodiments.

FIG. 2 illustrates an example architecture of a temporal transformer.

FIGS. 3A-3B illustrate two example comparisons between outputs produced by the improved NeRF-based model discussed herein and a prior NeRF-based model at two different novel viewpoints given one RGB-D video as an input.

FIGS. 4A-4C illustrate some additional comparisons between outputs produced by the prior NeRF-based model, the prior NeRF-based model additionally using depth information, and the improved NeRF-based model discussed herein across various poses, viewpoints, and subjects.

FIG. 5 illustrates an effect of using an appearance code during training of a NeRF-based model.

FIG. 6 illustrates an effect of using a temporal transformer during training of a NeRF-based model.

FIG. 7 illustrates an example method for training the improved NeRF-based model discussed herein for novel view and unseen pose synthesis, in accordance with particular embodiments.

FIG. 8 illustrates an example computer system.

### DESCRIPTION OF EXAMPLE EMBODIMENTS

3D human digitization has drawn significant attention in recent years, with a wide range of applications such as photo editing, video games and immersive technologies. To obtain photo-realistic renders of free-viewpoint videos, existing approaches require complicated equipment with expensive synchronized cameras, which makes them difficult to be applied to realistic scenarios. To date, modeling detailed appearance of dynamic clothed humans such as cloth wrinkles and facial details such as eyes from videos remains a challenging problem.

To represent static scenes, NeRF-based models learn an implicit representation using neural networks, which has enabled photo-realistic rendering of shape and appearance from images. Specifically, NeRFs represent a static scene as a radiance field and render the color using classical volume rendering. With dense multi-view observations as input, NeRF encodes density and color as a function of 3D coordinates and viewing directions by MLPs along with a differentiable renderer to synthesize novel views. For instance, NeRF utilizes the 3D location x=(x, y, z) and 2D viewing direction d as input and outputs color c and volume density σ with a neural network for any 3D point as follows:

F_{θ}:(yₓ(x),y_{d}(d))→(c,σ). (1)

To render the color of an image pixel, NeRF uses the volume rendering integral equation by accumulating volume densities and colors for all sampled points along the camera ray. Let r be the camera ray emitted from the center of projection to a pixel on the image plane. The expected color of that pixel bounded by hₙ and h_{f} is then given by:

C̆(r)=∫ₕ_{ₙ}^{h}^{_{f}}T(h)σ(r(h))c(r(h),d)dh, (2)

where T(h)=exp(−∫ₕ_{ₙ}^{h}^{_{f}}σ(r(s))ds). The function T(h) denotes the accumulated transmittance along the ray from hₙ to h. Usually for synthesizing novel views of static scenes, NeRF is trained on a collection of images for each static scene with known camera parameters, and can render scenes with photo-realistic quality.

While existing NeRF-based models show unprecedented visual quality on static scenes, applying them to high quality free-viewpoint rendering of humans in dynamic videos remains a challenging task. To generalize NeRF from static scenes to dynamic videos, one example approach (e.g., Dynamic NeRF or D-NeRF) encodes a time step t to differentiate motions across frames and converts scenes from the observation space to a shared canonical space in order to model the neural radiance field. As such, they can handle dynamic scenes to some extent but the poses remain uncontrollable by users. Furthermore, some approaches introduce human pose as an additional input to serve as a geometric guidance for different frames. However, they either cannot generalize to novel poses or need more than one input view.

To overcome these limitations, particular embodiments described herein relates to an improved method or technique for training an improved NeRF-based model for high fidelity novel view and unseen pose synthesis by learning implicit radiance fields based on pose and appearance representations. The improved NeRF-based model leverages a pose code anchored to the human pose and an appearance code anchored to the point clouds that may model the shape of the human and may help fill in the missing parts in the body, respectively. Specifically, the improved model leverages a human pose extracted from a parametric body model as a geometric prior to model motion information across image frames. Shared latent codes anchored to the human poses are optimized, which may integrate information across frames. To generalize the improved model to unseen poses, appearance information is encoded into the model with the assist of a single-view RGB image and corresponding depth image (also herein referred to as an RGB-D image). The model learns an appearance code anchored to incomplete point clouds in the 3D space. Point clouds may be obtained by using single-view depth information to lift the RGB image to the 3D space, which provides partial visible parts of the human body. The learned implicit representation enables reasoning of the unknown regions and complements the missing details on the human body.

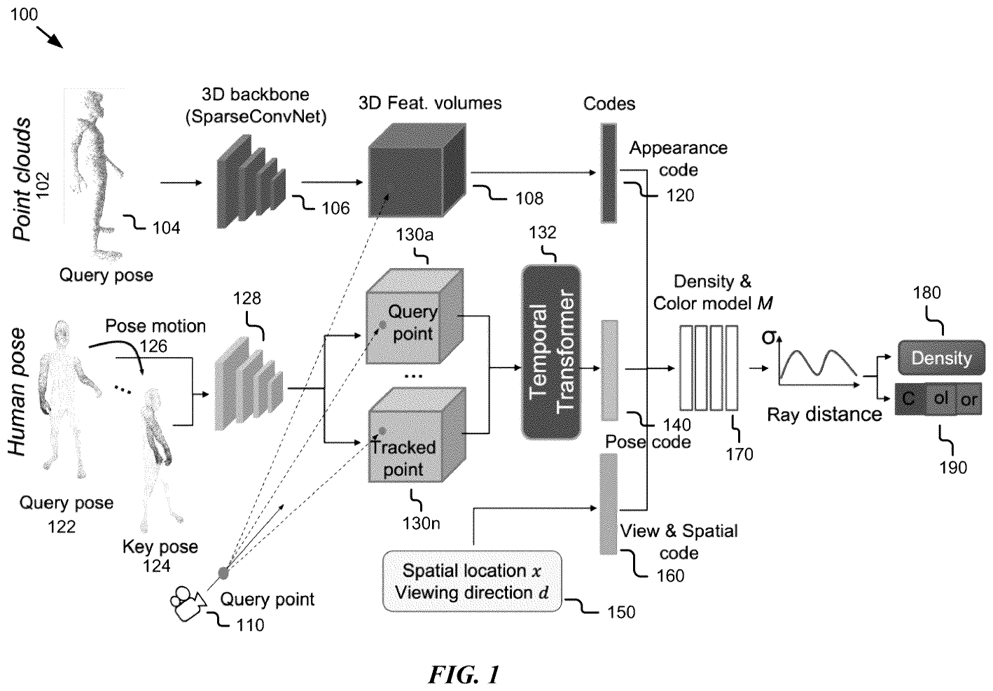

To further leverage temporal information from multiple frames of a dynamic scene video, a temporal transformer is used to aggregate trackable information. The temporal transformer may help recover more non-visible pixels in the body. To achieve this, the parametric body model may be used to track points from a query frame to a set of key/reference frames. Then, based on the learned implicit representation and/or tracked information, the temporal transformer outputs a pose code across frames. The resulting pose code (e.g., generated using the temporal transformer) and appearance code (e.g., generated using point clouds) along with camera pose information (e.g., spatial location, viewing direction) may be used to train a neural network (e.g., improved NeRF-based model) to predict a density and color for each 3D point or pixel of the image to render from a desired novel viewpoint. The training process is discussed in detail below in reference to FIG. 1.

Some of the notable features and contributions associated with the improved NeRF-based model are as follows: (1) a new framework is introduced with monocular RGB-D as input, (2) significant improvement is observed on the unseen poses compared to existing methods, with high-fidelity reconstruction of fine-level details (e.g., face details, cloth wrinkles, body details, logos, etc.) at a resolution and fidelity, which the prior works (e.g., NeuralBody) was not able to achieve, (3) pose and appearance representations are combined by modeling shared information across frames and specific information at each individual frame. These two representations help the model to generalize better to novel poses compared to only utilizing the pose representation, (4) a temporal transformer is used to combine information across frames, which helps to recover non-visible details in the query frame, especially at unseen poses or views, and (5) the improved NeRF-based model is extensively evaluated against state-of-the-art techniques on several sequences of humans in motion and exhibits significantly higher rendering quality of novel view and novel pose synthesis.

### Training of Improved NeRF-Based Model

FIG. 1 illustrates an overall training process 100 for training the improved NeRF-based model for novel view and unseen pose synthesis of dynamic scenes. It should be noted that the training process 100 here depicts steps performed during a single training iteration. The same steps may be repeated for several iterations until the model is deemed to be sufficiently complete. As an example and not by way of limitation, the training process 100 may be repeated for 30 iterations, where each iteration includes rendering an image from a particular camera viewpoint (e.g., 1 of 30 different camera viewpoints), an RGB-D image associated with that particular camera viewpoint, a window or a sequence of image frames (e.g., 10 RGB-D images), and a set of key/reference frames (e.g., 3 key frames). The RGB-D image that is used for generating the appearance code may be one of the window or sequence of image frames (e.g., 10 RGB-D images) or it may be a different one. In one example implementation, the model discussed herein is trained for 30 different camera viewpoints.

At a high level, training the improved NeRF-based model discussed herein includes generating, at each training iteration, three different codes or latent representations including (1) an appearance code (also interchangeably referred to herein as a first latent representation) 120, (2) a pose code (also interchangeably referred to herein as a second latent representation) 140, and (3) a view & spatial code (also interchangeably referred to herein as a third latent representation) 160, and then feeding these three codes into a density and color model 170, which is basically the NeRF, to output a color 180 and a density 190 value for each pixel of an image to be rendered from a specific viewpoint (e.g., desired novel viewpoint). The generated color and density values are then compared with color and density values of a ground-truth image and the model 170 is updated based on the comparison. It should be noted that the ground-truth image used here for the training may be the same as the input RGB-D image that is used for generating the appearance code 120. Specific steps for generating the appearance code 120, the pose code 140, and the view and spatial code 160 are now discussed in detail below.

First, to generate the appearance code 120, a particular image or query frame (e.g., RGB image) of a dynamic scene and depth information (e.g., depth image) associated with the single image frame may be accessed. As mentioned elsewhere herein, an image along with depth information is herein referred to as an RGB-D image. As an example, the RGB-D image used for generating the appearance code 120 may be a frontal view of a person sitting on a chair. Such frontal view may be captured using a webcam. In some embodiments, a monocular RGB image may serve as the appearance prior for the human body under one view. To learn detailed information at each individual frame, the appearance code may be anchored to the point clouds. The RGB-D image may be used to generate point clouds 102. In particular embodiments, the point clouds 102 may be generated by lifting the RGB image into the 3D space using the depth image. For instance, for each pixel in the RGB image, depth (e.g., distance from camera) is used to trace the pixel in the 3D space to get the point clouds 102. The point clouds generated in this way model the partial body of the human performer and show details such as wrinkles on the clothes. Given a 2D pixel pₜⁱ, and corresponding depth value dₜⁱ, the point clouds generation process may be formulated as:

pₜ^{s}^{ᵢ}=F_{φ}(pₜⁱ,dₜⁱ). (3)

Here pₜ^{s}^{ᵢ} is the 3D point generated by the 2D pixel for frame t. F( . . . ) is the function generating a 3D point given a 2D pixel and camera pose. Different from the pose-conditioned latent codes (e.g., pose code 140) that are shared across all frames, here the proposed appearance-conditioned codes are anchored to the point clouds, which are obtained from the pixel-aligned features extracted from an image encoder E.

From the point clouds 102, a query pose 104 may be generated. In particular embodiments, the query pose 104 may be generated by tracking or fitting points from the point clouds 102 onto a 3D body model or mesh. The 3D body model may be predefined and retrieved from a data store. As an example and not by way of limitation, the 3D body model may represent a skeleton or template of a person and the query pose 104 may be obtained by morphing the body model according to the points from the point cloud 102.

Since the query pose 104 is now represented in the 3D space, a network may be needed to extract features from such 3D space. As depicted, a 3D backbone or a sparse convolution neural network 106 (also interchangeably herein referred to as SparseConvNet) may be used to extract the features from the query pose 104 and generate a 3D feature volume 108. The 3D feature volume 108 may include feature vectors corresponding to the features extracted from the query pose 104 using the 3D backbone 106. In some embodiments, to take advantage of the rich semantic and detailed cues from images, a 2D convolution network (e.g., ResNet34) may be used to encode the image feature map E(Iₜ) for the given image Iₜ. Specifically, features may be extracted from the ResNet34, and then three convolutional layers may be utilized to reduce the dimension followed by a SparseConvNet to encode the features anchored to the sparse point clouds.

To obtain a subset of features corresponding to one or more points of interest of the dynamic scene and encode this subset of features into the appearance code 120, camera rays may be cast or shoot from a particular camera point or query point 110 into the 3D feature volume 108. The subset of features may be extracted based on the camera rays hitting at several points/locations in the 3D feature volume 108. Using the subset of features extracted from the 3D feature volume 108, another neural network (e.g., encoder) may be used to encode the subset of features into the appearance code or first latent representation 120. In some embodiments, to obtain the appearance code for each point sampled along the camera ray, a trilinear interpolation may be utilized to query the code at the continuous 3D locations. ψ(xⁱ_{t,}, E) is adopted to represent the appearance code for point xⁱₜ. The appearance code 120 together with a pose code (e.g., pose code 120) may be forwarded into a neural network (e.g., density and color model 170) to predict a density and color per pixel of an image to render, as discussed in further detail below. The appearance code learned on each single frame may model the details on the human body and help recover some missing pixels in the 3D space. For instance, the appearance code 120 encodes appearance information or fine-level details of one or more objects in a dynamic scene. The dynamic scene may include the one or more objects in motion. For example, if the dynamic scene includes a person in motion, then the appearance code encodes facial characteristics of the person, body characteristics of the person, cloth wrinkles, details of clothes that the person is wearing, etc.

Next, to generate the pose code or the second latent representation 140, a window or a sequence of image or query frames (e.g., 10 RGB images) of the dynamic scene and along with their corresponding depth information (e.g., corresponding 10 depth images) may be accessed. The sequence of image frames and corresponding depth information (e.g., 10 RGB-D images) may be representing the one or more objects of the dynamic scene during a particular time segment. For example, if the dynamic scene is a 2-minute video of a baby dancing, then the sequence of RGB-D images may be representing a 10-second portion of the baby dancing in that video. In some embodiments, the window or sequence of RGB-D images may include the particular RGB-D image that was used for generating the appearance code, as discussed above. For example, if there are 10 RGB-D images used for generating the pose code 140, then 1 out of these 10 RGB-D images may be used for generating the appearance code 120. In other embodiments, the particular RGB-D image used for generating the appearance code 120 is different from the window or sequence of RGB-D images used for generating the pose code 140. As an example, the RGB-D image used for the appearance code 120 may be the current frame (e.g., 11^{th} frame) of the dynamic scene and the RGB-D images used for the pose code 140 may be the previous window of frames (e.g., previous 10 frames) of the dynamic scene.

In addition to the window or sequence of images frames (e.g., 10 RGB-D images), a set of key or reference frames may be accessed. The key frames may be used as reference frames to fill-in or complete missing details of the one or more objects in the dynamic scene from a particular viewpoint (e.g., query point 110) that maybe different from the viewpoint(s) from which the sequence of image frames is captured. For example, if the sequence of image frames is captured from a front or a center viewpoint depicting a front pose of a person, but the particular viewpoint from which to render the dynamic scene is a side viewpoint (e.g., view the person from the side), then the key frames are used to provide those side details (e.g., side pose) of the person. In particular embodiments, the set of key frames may be predefined, such as three key frames captured from different camera angles or viewpoints. For example, a first key frame may be captured from a center camera, a second key frame may be captured from a left camera, and a third key frame may be captured from a right camera. In particular embodiments, the three key frames may be automatically selected from the training frames. Distances between all training poses and the pose may first be calculated for the query frame Sₜ by ∥Sₜ−Sⱼ∥₂(j∈N_{f}) and frames with K-NN distances may be kept. Here S are the coordinates of the vertices extracted from the body mesh and K is set to 2. In addition, the first frame may be selected as the fixed key frame. For simplicity, the key frame selection strategy may not be trained with the whole model.

Each RGB-D image associated with the window or sequence of image frames and the set of key frames is used to generate a point cloud. As discussed elsewhere herein, a point cloud may be generated by lifting the RGB image using depth into the 3D space. A point cloud corresponding to each image frame of the sequence of image frames (e.g., 10 RGB-D images) is used to generate a query pose 122 and a point cloud corresponding to each key frame is used to generate a key pose 124. For each frame, we assume a 3D human model or 3D body model is given. The query pose 122 or the key pose 124 may be generated by tracking or fitting the points from their respective point clouds onto the 3D human model or mesh, as discussed elsewhere herein. For instance, vertices from the posed 3D mesh may first be extracted and a set of pose codes Z={z¹, z², . . . , [symbol] may be anchored to the vertices of the human body model at frame t. Here Nₘ denotes the number of codes. The dimension of each pose code may be set to 16. Then the implicit representation is learned by forwarding the pose code into a neural network, which aims to represent the geometry and shape of a human performer. The pose space may be shared across all frames, which may be treated as a common canonical space and enables the representation of a dynamic human based on the NeRF.

The pose codes anchored to the body model are relatively sparse in the 3D space and directly calculating the pose codes using trilinear interpolation would lead to less effective features for most points. To overcome this challenge, a sparse convolutional neural network 128 (e.g., SparseConvNet) may be used which propagates the codes defined on the mesh surface to the nearby 3D space. Specifically, to acquire the pose code for each point sampled along a camera ray, the trilinear interpolation may be utilized to query the code at continuous 3D locations. Here the pose code for point xⁱₜ at frame t is represented by ϕ(xⁱₜ, Z) and will then be forwarded into a neural network (e.g., density and color model 170) to predict the density and color, as discussed elsewhere herein.

In particular embodiments, a sequency of query poses 122 corresponding to the sequence of image frames and a sequence of key poses 124 corresponding to the set of key frames may be generated. By way of an example and not limitation, if there are 10 images frames in the sequence and 3 key frames, then 10 query poses and 3 key poses may be generated. The sequence of query poses 122 may represent pose motion 126 (e.g., human in motion, baby dancing, person walking, etc.).

Similar to the 3D backbone or SpareConvNet 106 used for extracting features and generating a 3D feature volume with respect to the appearance code 120, a 3D backbone or sparse convolutional neural network 128 may be used to extract features from each of the query poses 122 and key poses 124 and generate corresponding 3D feature volumes 130a . . . 130n (individually and/or collectively herein referred to as 130). In the example discussed above with 10 query poses and 3 key poses, a total of 13 3D feature volumes 130 may be generated, where 10 feature volumes correspond to the 10 query poses and 3 feature volumes correspond to the 3 key poses. A subset of features from each of these 3D feature volumes 130a . . . 130n may be extracted by casting/shooting camera rays from the query point 110 into the 3D feature volume 130.

Next, based on the extracted subset of features, point tracking may be performed to identify a first correspondence between a feature of interest corresponding to the query point 110 and same feature across all different frames at different times. For example, if the feature of interest is a fingertip of the person, then that same fingertip is tracked between all the frames (e.g., 10 query frames+3 key frames) across time. Also, a second correspondence or relationship between the feature of interest (e.g., fingertip) and other features (e.g., eye lashes, lips, nose, chin, etc.) in each frame is determined. In some embodiments, to perform point tracking, first, Nₛ points on each face of the mesh may be randomly sampled, which result in Nₛ×Nₘ points on the whole surface of a human body. Here Nm represents the number of faces. Then distance may be calculated between a 3D point sampled on the camera ray and all points on the surface at the query frame Iₜ. Here each sample x^{j}ₜ close to the surface may be kept for rendering the color if min_{v∈Vt}∥xₜⁱ−v∥₂<y and the nearest point \hat{x}ₜⁱ on the surface at frame Iₜ may be obtained, where Vₜ is the set of sampled points. In addition, the points at different frames that match \hat{x}ₜⁱ by the body motion may be tracked, and the feature of the tracked points may be assigned to x^{j}ₜ.

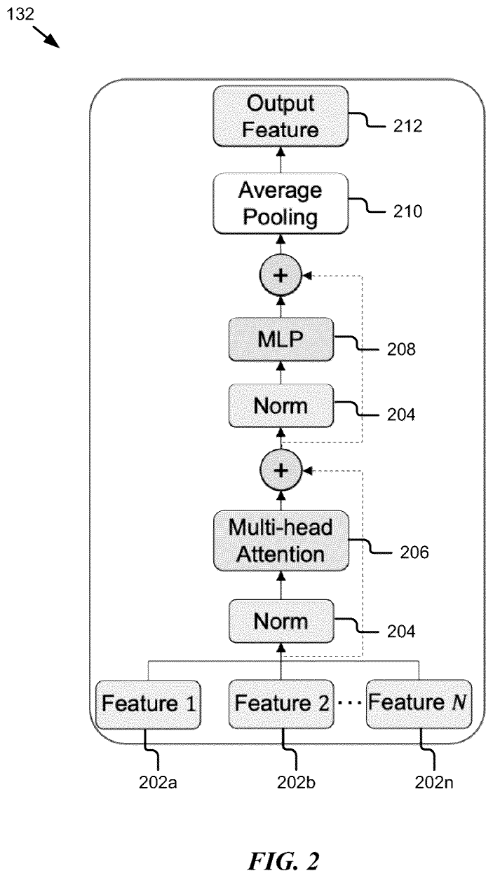

The extracted subset of features from the generated 3D feature volumes 130a, . . . 130n (e.g., 13 feature volumes or cubes) along with (1) first correspondence information identifying the temporal relationship between a feature of interest corresponding to the query point 110 and same feature across all different frames (e.g., 10 query frames and 3 key frames) at different times and (2) second correspondence information identifying the relationship between the feature of interest and other features in each frame may be feed into a temporal transformer 132. The temporal transformer 132 may weigh the input information (i.e., the extracted subset of features from the 3D feature volumes 130, the first correspondence information, and the second correspondence information), combine results based on the weightings, and accordingly generate the pose code 140. Due to the temporal transformer combining information between the query poses and the key poses, any missing details (e.g., pose) of the object(s) in the dynamic scene are fully captured. Also, the resulting pose of the person is temporally smooth. The temporal transformer 132 is discussed in further detail below in reference to at least FIG. 2.

FIG. 2 illustrates an example architecture of a temporal transformer 132. Frames from different time steps may provide complementary information to a query frame. Given the features extracted from the key frames, a temporal transformer 132 may be utilized to effectively integrate the features (e.g., between the key frames and one or more query frames). To obtain corresponding pixels in a key frame, the body model extracted from each frame may be used to track the points, as discussed above. Given the pose codes from the query point and tracked points as input, the temporal transformer 132 aims to aggregate the codes by using a transformer-based structure. Specifically, after obtaining the pose code from N frames (e.g., K+1 key frames and one or more query frames), a transformer-based structure may be employed to take N features 202a, 202b, . . . , 202n (e.g., subset of features extracted from the generated 3D feature volumes 130 along with point tracked information between the key frames and one or more query frames) as input and utilize a multi-head attention component 206 and feed-forward multi-layer perceptron (MLP) 208 for feature aggregation. There may also be residual connections around each of the multi-head attention component 204 and the MLP 206 followed by a layer normalization 204. In particular embodiments, the multi-head attention component 206 applies a specific attention mechanism called self-attention. Self-attention allows the temporal transformer 132 to associate each input feature to other features. More specifically, the multi-head attention component 206 is a component in the temporal transformer 132 that computes attention weights for the input and produces an output vector with encoded information on how each feature should attend to other features in the sequence of features 202a, 202b, . . . , 202n (individually and/or collectively herein referred to as 202).

In some embodiments, prior to feeding the features 202 into the multi-head attention component 206, the features 202 may go through a layer normalization 204. The normalized features may then go through the multi-head attention component 206 for further processing. The multi-head attention component 206 may generate a trainable associate memory with a query, key, and value to an output via linearly transforming the input. Given the input feature ϕ(xⱼⁱ, Z), the query, key, and value may be represented by f_{q}(ϕ(xₜⁱ, Z)), fₖ(ϕ(xₜⁱ, Z)) and fᵥ(ϕ(x^{j}ₜ, Z)), respectively. The query and the key may be used to calculate an attention map using the multiplication operation, which represents the correlation between all the features 202. The attention map may be used to retrieve and combine the feature in the value. Formally, the attention weight for point x^{j}ₜ in frame t and tracked point xₖⁱ in frame k may be calculated by:

$${a}_{t , k}^{i} = ψ ( \frac{{f}_{q} ( ∅ ( {x}_{t}^{t} , Z ) ) \cdot {f}_{k} ( ∅ ( {x}_{k}^{t} , Z ) ) T}{\sqrt{d}} ) \qquad ( 4 )$$

where \sqrt{d} is a scaling factor based on the network depth, and ψ(•) denotes the softmax operation. The aggregated feature for input ∅(xₜⁱ, Z) is formulated as:

∅′(xₜⁱ,z)=Σ_{keK}∅(xₜⁱ,Z)·α_{t,k}ⁱ+fᵥ(∅(xₜⁱ,Z)), (5)

where K denotes the index set of the combined frames.

In some embodiments, multi-head self-attention may be adopted by running multiple self-attention operations, in parallel. The results from different heads may be integrated to obtain the final output (e.g., output feature 212). After the processing by the multi-head attention component 206 and the MLP 208, each input feature 202 contains its original information and also takes into account the information from all other frames. As such, the information from key frames and the one or more query frames may be combined together. Average pooling 210 may then be employed to integrate all features, which serves as the output 212 of the temporal transformer 132. The output 212 may be the pose code 140. It should be noted that any positional encoding is not adopted on the input feature sequence.

The pose code 140 learned in the shared space on all frames (e.g., one or more query frames and set of key frames) may model the human shape well in both known and unseen poses. Fine-level details on each frame under novel poses may be provided by the appearance code 120, as discussed elsewhere herein.

Next, to generate the view and spatial code or the third latent representation 160, camera pose information or camera parameters 150 may be accessed. The camera parameters 150 may include spatial location x and viewing direction d. For instance, the camera pose information or camera parameters 150 may indicate what the current camera direction or orientation is, what is the spatial location of object(s) in the dynamic scene, or particular viewpoint from which the dynamic scene needs to be rendered. In particular embodiments, the camera parameters 150 may be obtained from a user input, such as, for example, current mouse cursor or position when the user freely rotates the camera around the dynamic scene. A neural network (e.g., an encoder) may be used to process these camera parameters (e.g., spatial location x, viewing direction d) to generate the view and spatial code 160. As discussed elsewhere herein, the view and spatial code 160 encodes camera pose information that is used to render the dynamic scene from a particular viewpoint (e.g., desired novel viewpoint).

Responsive to generating the three codes or latent representations (i.e., the appearance code 120, the pose code 140, and the view & spatial code 160), these codes may be combined together and feed into a neural network, such as the density and color model 170. The density and color model 170 is basically the improved NeRF-based model discussed herein. For each frame, the network (e.g., the density and color model 170) takes the appearance code 120, the pose code 140, and view and spatial code 160 including spatial location and viewing direction as the inputs and outputs the density 180 and color 190 for each point in the 3D space. Positional encoding may be applied to both the viewing direction d and the spatial location x by mapping the inputs to a higher dimensional space. For frame t, the volume density and color at point x^{j}ₜ is predicted as a function of the latent codes, which is defined as:

(σₜⁱ,cₜⁱ)=M(Ø(xₜⁱ,Z),ψ(xₜⁱ,E),γ_{d}(dₜⁱ),γₓ(xₜⁱ)), (6)

where M(•) represents a neural network (e.g., density and color model 170). γ_{d}(dₜⁱ) and γₓ(xₜⁱ) are the positional encoding functions for viewing direction and spatial location, respectively.

The model 170 may generate a density 180 and a color 190 value per pixel of an image to render from the particular viewpoint (e.g., query point 110) for a particular training iteration (e.g., 1^{st} iteration of 30 training iterations). These density and color values for all pixels may be combined together to generate an image, which is rendered from the particular viewpoint (e.g., desired novel viewpoint). The generated image may be compared to the corresponding ground-truth image (e.g., actual or true image rendered from the particular viewpoint) to compute a loss or error between the two images. For example, if the ground-truth image i was captured by camera I, the pixel rendered using the camera pose of camera I would be compared to the ground-truth image i. The loss between the generated image by the model 170 and the ground-truth image may be used to update one or more trainable components associated with the model 170. As an example and not by way of limitation, the loss may be used to update the neural networks used to generate the three codes 120, 140, and 160, and also the density and color model 170. After updating the model, the training process 100 may again be repeated for the next iteration, which includes a second camera viewpoint (e.g., 2^{nd} camera viewpoint of the 30 camera viewpoints), an RGB-D image associated with that second camera viewpoint, a window or a sequence of image frames (e.g., 10 RGB-D images), and the predefined set of key/reference frames (e.g., 3 key frames). In some embodiments, the key frames may be predefined and remain the same during the entire training as well the inference process. For example, the same 3 key frames are used throughout the training process 100.

In particular embodiments, the improved NeRF-based model discussed herein may be optimized or updated using the following objective function:

[symbol]

= [symbol] _{c1}+ [symbol] _{c2}, (7)
where [symbol] _{c1} and [symbol] _{c2} denote the reconstruction loss for the rendered pixels and image loss for the image decoder network D. The image decoder may include multiple Conv2D layers behind the ResNet34, which aims to reconstruct the input image. The color of each ray may be rendered using both the coarse and fine set of samples. The mean squared error between the rendered pixel color C̆_{c}(r) and ground-truth color C(r) may be minimized for training. L_{c1} may be computed as follows:

[symbol]

_{c1}=Σ_{r∈R}∥C̆_{c}(r)−C(r)∥₂²+∥C̆_{f}(r)−C(r)∥₂², (8)

where R is the set of rays. C̆_{c}(r) and C̆_{f}(r) denote the prediction of the coarse and fine networks. L_{c2} may be computed as follows:

[symbol]

_{c2}=Σ_{p∈I}∥Ĭ(p)−I(p)∥₂², (9)

The symbol Ĩ(p) and I(p) represent the reconstructed and ground truth colors for pixel p. I is the set of pixels.

In particular embodiments, the training process 100 discussed above may rely on four sequences of real humans in motion that may be captured with a 3dMD full-body scanner as well as a single sequence of a synthetic human in motion. The 3dMD body scanner may include 18 calibrated RGB cameras that may capture a human in motion performing various actions and facial expressions and output a reconstructed 3D geometry and material image file per frame. These scans tend to be noisy but may capture facial expressions and fine-level details like cloth wrinkles. The synthetic scan may be a high-res animated 3D human model with synthetic clothes (e.g., t-shirt and pants) that were simulated. Unlike the 3dMD scans, this 3D geometry is very clean, but it lacks facial expressions. RGB and Depth for all real and synthetic sequences may be rendered from 31 views at a certain resolution (e.g., 2048×2048 resolution) that covers the whole hemisphere (e.g., very similar to the way that NeRF data is generated) at 6 fps using Blender Cycles.

In some embodiments, the number of video frames used for the training may vary between 200 to 600 depending on the sequence. The image resolution for the training and test may be set to 1024×1024. To train the model, the first half of the frames may be selected for training and the remaining frames may be selected for inference, as discussed in further detail below. Both training and test frames may contain large variations in terms of the motion and facial expressions. At training and test stages, a single RGB-D image at each frame may be used as the input. All the input RGB-D images at different frames may share the same camera pose. In addition, 29 more views with different camera poses may be used to train the model discussed herein. The output is a rendered view given any camera pose (not including the camera pose of the input RGB-D image).

### Testing of Improved NeRF-Based Model

Once the improved NeRF-based model is sufficiently trained using the training process 100 discussed above (e.g., model is trained based on several iterations or different camera viewpoints), the model may be used to perform novel view and unseen pose synthesis of a particular dynamic scene at inference or test time. By way of an example and not limitation, if are a total of 1000 frames associated with a dynamic scene or video and 800 of these 1000 frames are used for training the model, then remaining 200 frames may be used for testing the trained model from different viewpoints.

During inference time, the process for rendering an image is mostly the same as discussed in reference to the training process 100. However, there are some differences between the training time and test/inference time, particularly with respect to a pose code generation. For instance, the process for generating an appearance code and a view and spatial code is the same as discussed above with respect to the training process 100 in FIG. 1. However, the way a pose code is generated at test or inference time is different, particularly, with respect to the inputs that were used during the training time and inputs that are provided at inference. For instance, instead of using a window or sequence of image frames (e.g., 10 RGB-D images) or query poses, a single query frame (i.e., single RGB-D) is used here. Another difference is that the single query frame used here may be the same for both generating the appearance code as well as the pose code. It should be noted that the same set of key frames may be used at the test or inference time. Steps performed at the inference time are discussed below.

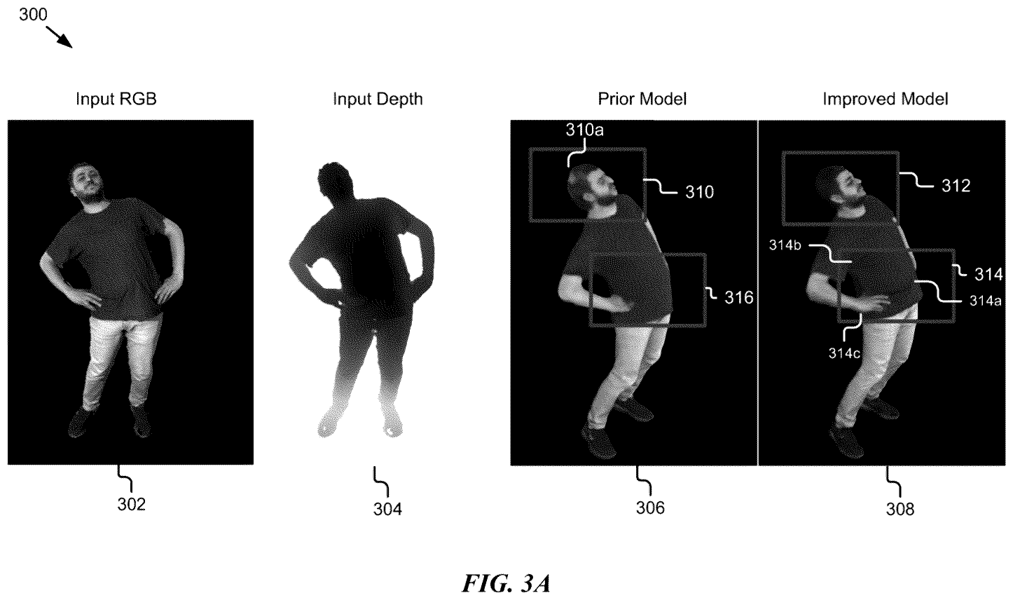

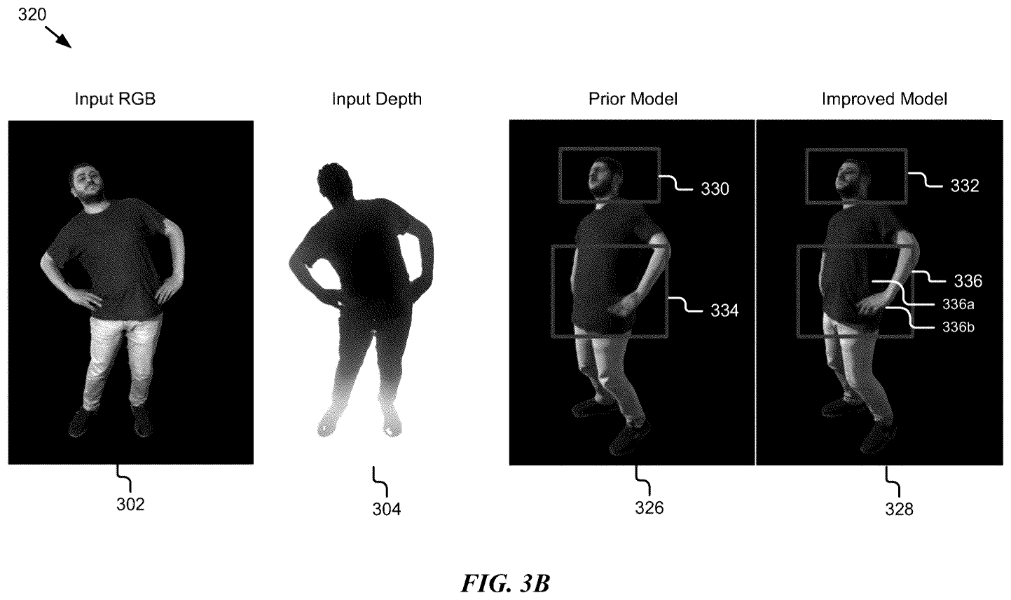

At test or inference time, a single query frame including an RGB image and corresponding depth (e.g., RGB-D image), a set of key frames (e.g., 3 key frames), and a desired novel viewpoint from which to render the image may be provided as inputs. For example, the query frame may be a frontal view of an archery pose of a person and the desired novel viewpoint may be a bird-eye viewpoint. As another example, as shown in FIG. 3A, the input query frame may include an input RGB 302 and depth 304 and the desired novel viewpoint may be a viewpoint as depicted in image 308.

Using the input query frame (e.g., RGB-D image), a system (e.g., computing system 800) may generate an appearance code. For instance, the system may generate the appearance code by converting the RGB-D image into a point cloud, generating a query pose (e.g., showing a person in an archery position) by tracking/fitting points from the point cloud onto a 3D body model/mesh, extracting 3D features using a 3D sparse convolutional network (e.g., SparseConvNet 106), generating a 3D feature volume (e.g., 3D volume 108) based on extracted features, casting/shooting camera rays from the desired novel viewpoint into the 3D feature volume, and extracting features of interest and encoding into the appearance code using a neural network.

Using the input query frame (e.g., RGB-D image) and the set of key frames, the system (e.g., computing system 800) may generate a pose code. For instance, the system may generate the pose code by converting the query frame and the set of key frames into query pose and key poses, respectively. For example, if there are 1 query frame and 3 key frames, then 1 query pose and 3 key poses are generated. Then the system may extract 3D features from these poses using a 3D sparse convolutional network (e.g., SparseConvNet 128). Based on the extracted features, the system may generate 3D feature volumes (e.g., 4 3D feature volumes corresponding to 1 query pose and 3 key poses). The system may cast camera rays from the desired novel viewpoint into each of the 3D feature volumes and extract features of interest from 3D feature volumes, where the features of interest may correspond to the desired novel viewpoint. The system may perform point tracking to identify a correspondence between a point of interest (e.g., query point) and same point across all different frames at different times. For example, if the point of interest is a fingertip of the person, then that same fingertip is tracked between all the frames (e.g., 1 query frame+3 key frames) across time. The point-tracked information along with the generated 3D volumes (e.g., 4 3D feature volumes) may then be feed into a temporal transformer, which combines all the information together and generates the pose code based on the combined information, as discussed elsewhere herein.

Using the input desired novel viewpoint, the system (e.g., computing system 800) may generate a view and spatial code. For instance, the system may generate the view and spatial code by accessing camera pose information including a spatial location and a viewing direction and processing the camera pose information using a neural network to generate the view and spatial code.

Once the appearance code, the pose code, and the view and spatial code are obtained, the system may feed these codes into the trained model i.e., improved NeRF-based model (e.g., density and color model 170) to generate color and density, per pixel, of the image to render from the desired novel viewpoint. Responsive to generating color and density values for all pixels, these pixels may be combined to generate the image, such as, for example, image 308 shown in FIG. 3A.

### Example Test Results of Improved NeRF-based Model

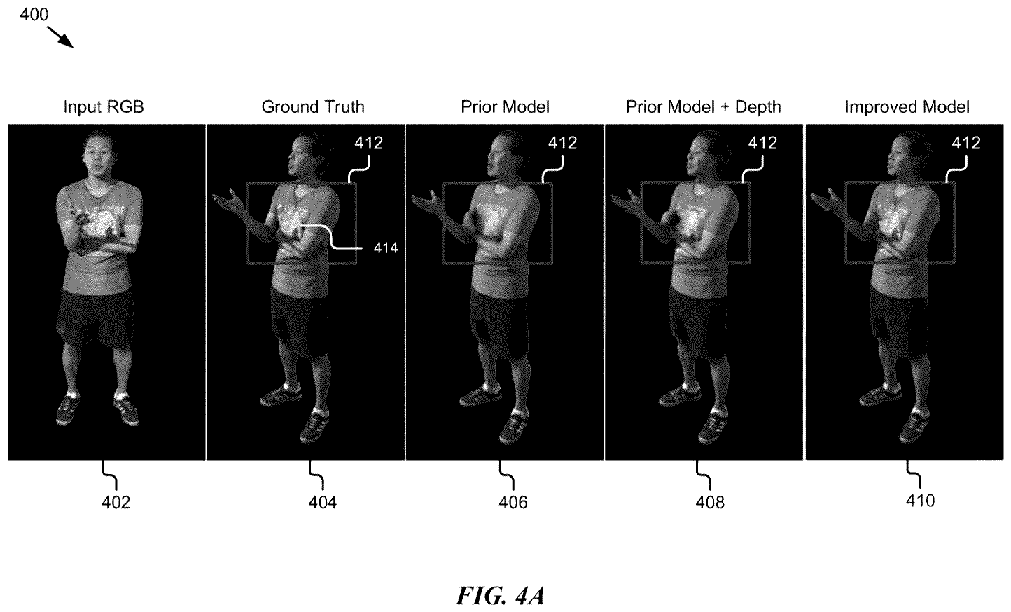

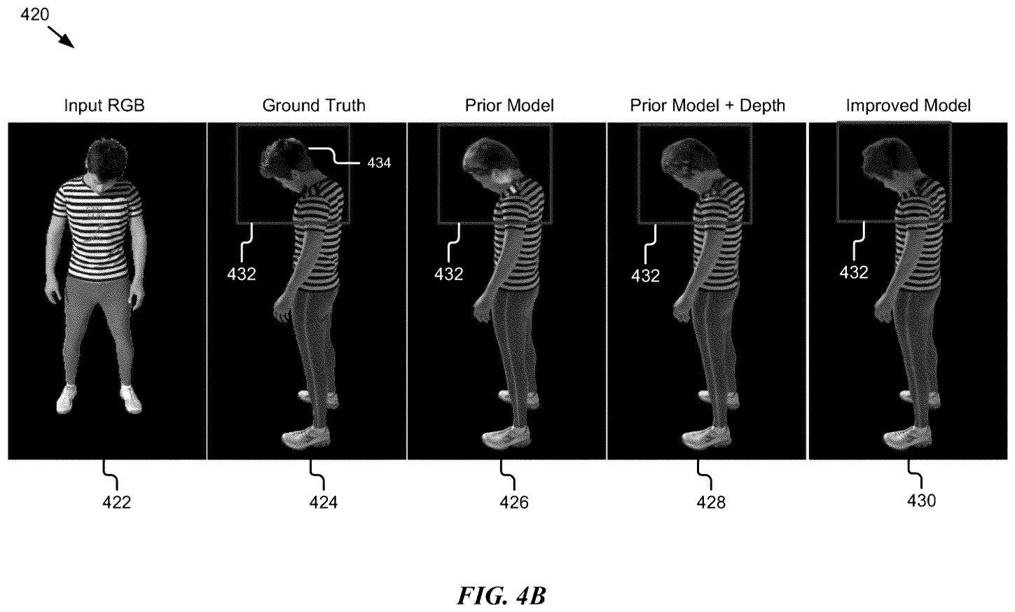

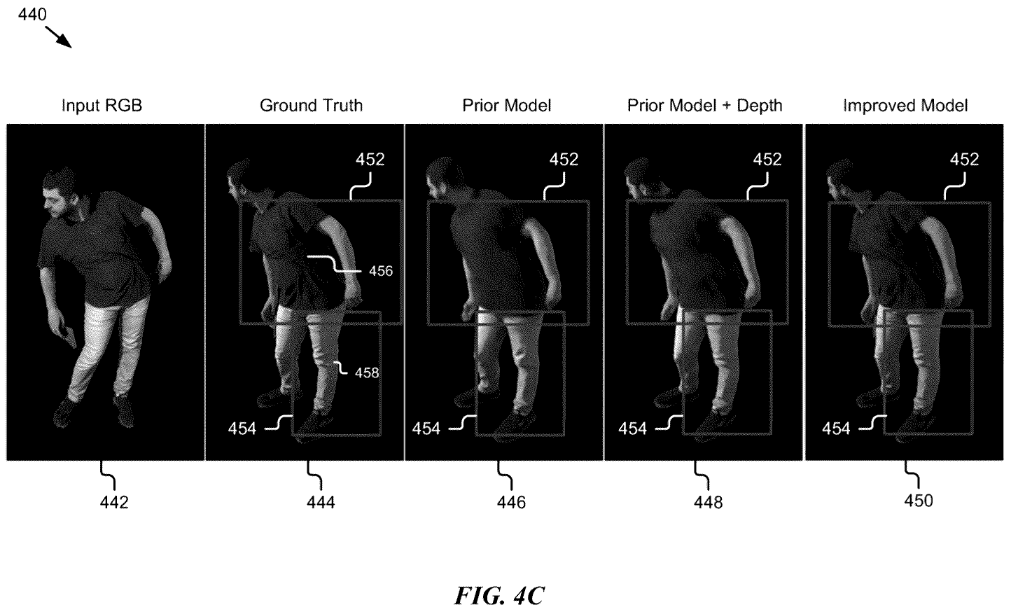

FIGS. 3A and 3B illustrate two example comparisons 300 and 320 between outputs produced by the improved NeRF-based model discussed herein and a prior NeRF-based model at two different novel viewpoints given one RGB-D video as an input. Specifically, FIG. 3A illustrates a first comparison 300 between an output 306 produced by the prior NeRF-based model and an output 308 produced by the improved NeRF-based model when these models render an input RGB image 302 from a first novel viewpoint. As discussed elsewhere herein, the prior model just uses the input RGB image 302 to generate the output image 306, whereas the improved NeRF-based model discussed herein uses both the input RGB image 302 and corresponding depth information 304 to generate the output image 308. Even when the prior model uses depth information, the results are still not comparable to that of the improved model, as shown and discussed in further detail below in reference to FIGS. 4A-4C.

As can be observed from seeing these output images 306 and 308 side-by-side, the improved model is able to predict novel views with body poses unseen from training with fine-level details (e.g., cloth wrinkles, facial characteristics, etc.), which the prior model fails to obtain. For instance, as shown by boxes 310 and 312, the facial characteristics of the person are much more refined and sharper in the output 308 produced by the improved NeRF-based model as compared to the output 306 produced by the prior NeRF-based model. Also, as shown in box 310, the output 306 produced by the prior NeRF-based model is missing some details 310a (e.g., hair) due to which it is giving the notion that the person is bald. Similarly, box 314 shows fine-level cloth details 314a and 314b (e.g., wrinkles) and body details 314c (e.g., person's hand) in the output 308 produced by the improved NeRF-based model. These fine-level cloth and body details are absent in the output 306 produced by the prior NeRF-based model, as shown by box 316.

FIG. 3B illustrates a second comparison 320 between an output 326 produced by the prior NeRF-based model and an output 328 produced by the improved NeRF-based model when these models render the same input RGB image 302 now from a second novel viewpoint. Here also one can observe by comparing these output images 326 and 28 that the improved model is able to predict novel views with body poses unseen from training with fine-level details (e.g., cloth wrinkles, facial characteristics, etc.), which the prior model fails to obtain. For instance, as shown by boxes 330 and 332, the facial characteristics of the person are much more refined and sharper in the output 328 produced by the improved NeRF-based model as compared to the output 326 produced by the prior NeRF-based model. Similarly, box 336 show fine-level cloth details 336a (e.g., wrinkles) and body details 336b in the output 328 produced by the improved NeRF-based model. These fine-level cloth and body details are again absent in the output 326 produced by the prior NeRF-based model, as shown by box 334.

FIGS. 4A-4C illustrate some additional comparisons between outputs produced by the prior NeRF-based model, the prior NeRF-based model additionally using depth information, and the improved NeRF-based model discussed herein across various poses, viewpoints, and subjects. It should be noted that all of these poses depicted in FIGS. 4A-4C are unseen and have not been used during for training. Specifically, FIG. 4A illustrates a first comparison 400 between an output 406 produced by the prior NeRF-based model, an output 408 produced by the prior NeRF-based model additionally using depth information, and an output 410 produced by the improved NeRF-based model when these models render a first input RGB image 402 from a first novel viewpoint. These outputs 406, 408, and 410 are compared to a ground-truth image 404. In particular, by looking at box 412, it may be observed that the output 410 produced by the improved NeRF-based model discussed herein is closest to the ground-truth image 404 and achieves significantly better render quality as compared to the output 406 produced by the prior NeRF-based model and the output 408 produced by the prior NeRF-based model using depth information. For instance, both the outputs 406 and 408 fail to achieve fine-level details 414 of person's t-shirt, which are captured in the output 410 produced by the improved NeRF-based model.

Similarly, FIG. 4B illustrates a second comparison 420 between an output 426 produced by the prior NeRF-based model, an output 428 produced by the prior NeRF-based model additionally using depth information, and an output 430 produced by the improved NeRF-based model when these models render a second input RGB image 422 from a second novel viewpoint. These outputs 426, 428, and 430 are compared to a ground-truth image 424. In particular, by looking at box 432, it may be observed that the output 430 produced by the improved NeRF-based model discussed herein is again closest to the ground-truth image 424 and achieves significantly better render quality as compared to the output 426 produced by the prior NeRF-based model and the output 428 produced by the prior NeRF-based model using depth information. For instance, both the outputs 426 and 428 fail to achieve fine-level details 434 of person's hair, which are captured in the output 430 produced by the improved NeRF-based model.

Similarly, FIG. 4C illustrates a third comparison 440 between an output 446 produced by the prior NeRF-based model, an output 448 produced by the prior NeRF-based model additionally using depth information, and an output 450 produced by the improved NeRF-based model when these models render a third input RGB image 442 from a third novel viewpoint. These outputs 446, 448, and 450 are compared to a ground-truth image 444. In particular, by looking at boxes 452 and 454, it may be observed that the output 450 produced by the improved NeRF-based model discussed herein is closest to the ground-truth image 444 and achieves significantly better render quality as compared to the output 446 produced by the prior NeRF-based model and the output 448 produced by the prior NeRF-based model using depth information. For instance, both the outputs 446 and 448 fail to achieve fine-level details 456 and 458 of the person's t-shirt and jeans, respectively, which are captured in the output 450 produced by the improved NeRF-based model.

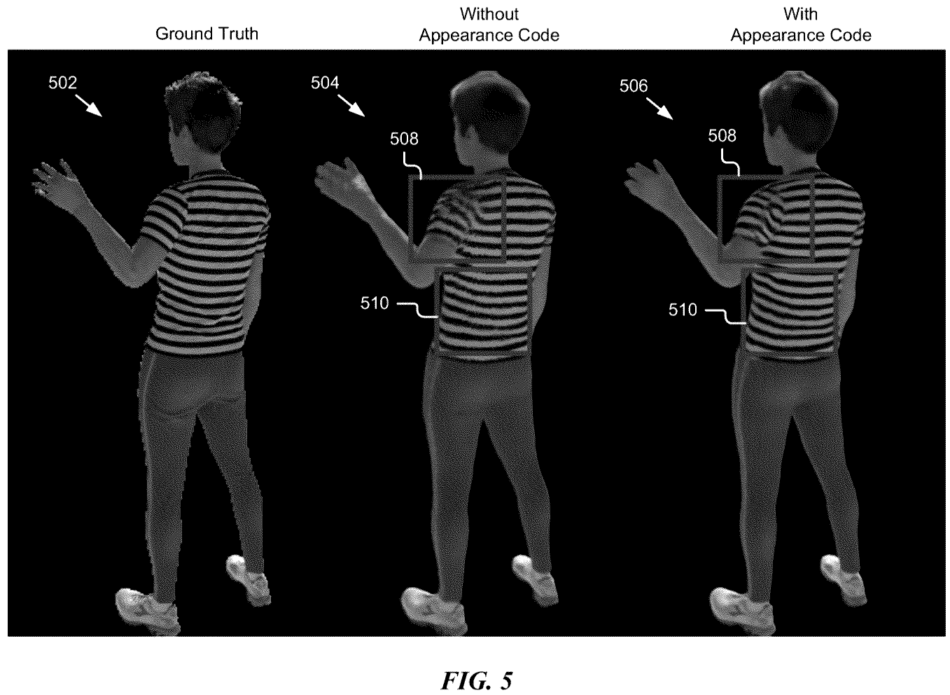

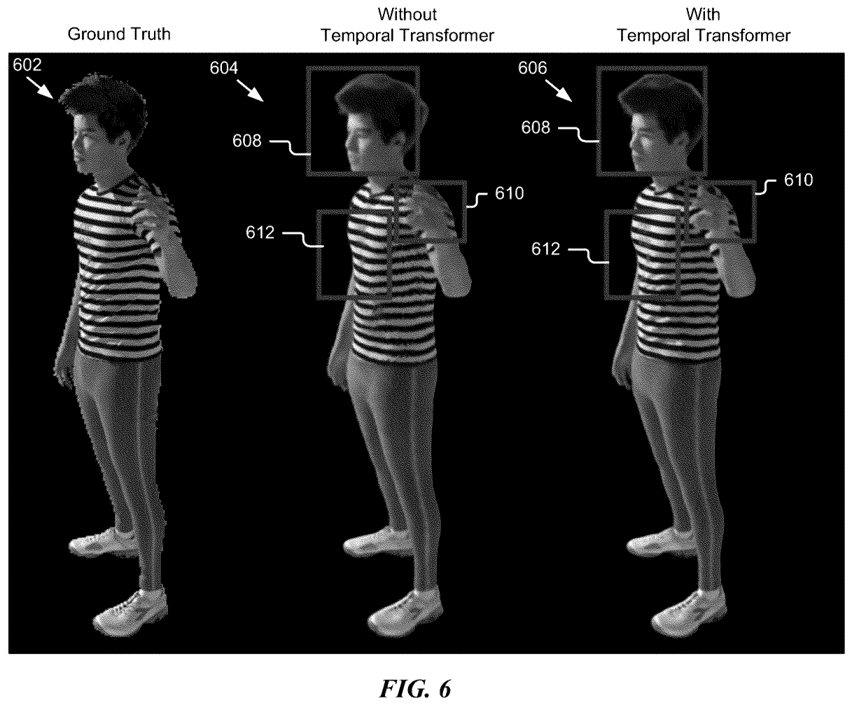

As shown and discussed in reference to FIGS. 3A-3B and 4A-4C, the improved NeRF-based model discussed herein is able to predict novel views with body poses unseen from training with fine-level details (e.g., cloth wrinkles, facial characteristics, etc.), which the prior model fails to obtain. Even when the prior model uses depth information, the results are still not comparable to that of the improved model, as shown and discussed in reference to FIGS. 4A-4C. Some of the reasons why the prior model fails to render these unseen body poses (e.g., body poses not seen during training) with high quality or fine-level details are, for example and without limitation, (1) the prior model does not take into account an appearance code or latent representation encoding fine-level details or appearance of the person, (2) the prior model does not take into account key or reference frames (e.g., frames providing missing details from different angles or viewpoints) during its training when generating a pose code. It has been observed that the rendering quality is improved when using key frames and performance increases with more key frames, (3) the prior model does not use a temporal transformer to generate a pose code combining temporal relationship between a sequence of query frames and key frames so that the resulting pose appears temporally smooth, and (4) the prior model does not generally uses depth information during its training. The effect of using an appearance code and a temporal transformer during the training of a NeRF-based model for novel view and unseen pose synthesis is further shown and discussed below in reference to FIGS. 5 and 6.

FIG. 5 illustrates an effect of using an appearance code during training of a NeRF-based model. In particular, FIG. 5 illustrates a ground-truth image 502, an image 504 produced by the NeRF-based model when trained without the appearance code (e.g., appearance code 120), and an image 506 produced by the NeRF-based model when trained with the appearance code (e.g., appearance code 120). As can be observed through boxes 508 and 510, the model trained with the appearance code produces an output (e.g., image 506) that has fine-level details of the person's t-shirt (e.g., smooth stripes). In contrast, these fine-level details appear non-uniformed and jagged in an output (e.g., image 504) produced by the model trained without the appearance code. Also, the output produced by the model trained with the appearance code is closer to the ground-truth image 502 and achieves significantly better render quality as compared to the output produced by the model trained without the appearance code. Therefore, using the appearance code brings performance improvement on the fine structures in different parts of the body, which demonstrates that the appearance code anchored to the point clouds may help recover the missing pixels in the query view.

FIG. 6 illustrates an effect of using a temporal transformer during training of a NeRF-based model. In particular, FIG. 6 illustrates a ground-truth image 602, an image 604 produced by the NeRF-based model when trained without the temporal transformer (e.g., temporal transformer 132), and an image 606 produced by the NeRF-based model when trained with the temporal transformer (e.g., temporal transformer 132). As can be observed through boxes 608, 610, and 612, the model trained with the temporal transformer produces an output (e.g., image 606) that is temporally smooth as compared to an output (e.g., image 604) produced by the model trained without the temporal transformer. Also, the output produced by the model trained with the temporal transformer is closer to the ground-truth image 602 and achieves significantly better render quality as compared to the output produced by the model trained without the temporal transformer. For example, facial features (as indicated by box 608), hand details (as indicated by box 610), and logo on the person's t-shirt (as indicated by box 612) appears much clearer and sharper in the image 606 than image 604. Therefore, utilizing the temporal transformer may help the model generate better rendering performance. For instance, as observed in the image 606, the details like logos on the shirt are finer, the hands are cleaner, and the face is significantly crisper.

### Example Method

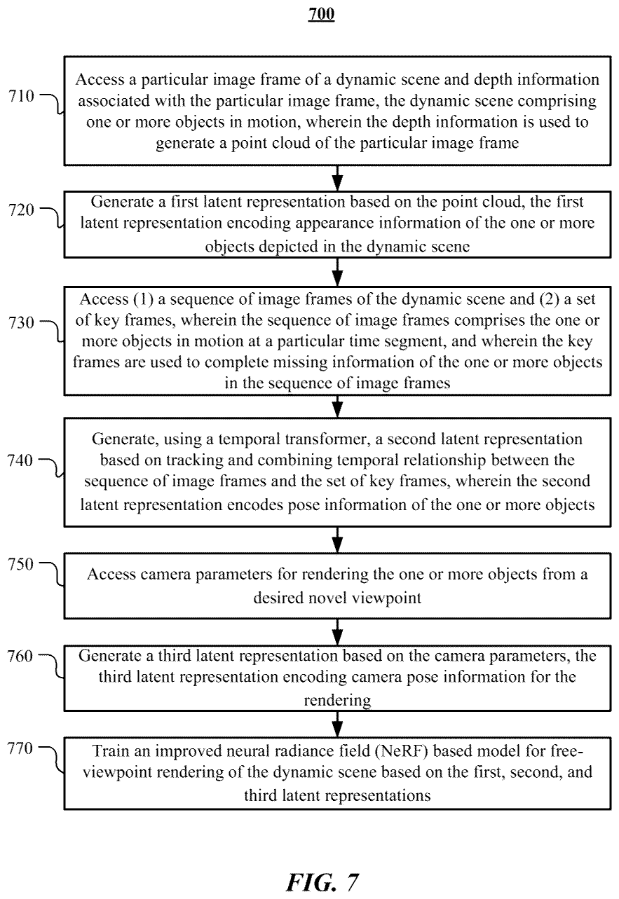

FIG. 7 illustrates an example method 700 for training the improved NeRF-based model discussed herein for novel view and unseen pose synthesis, in accordance with particular embodiments. Specifically, the method 700 illustrates steps (e.g., steps 710-770) performed by a computing system (e.g., computing system 800) during a single or one training iteration. These steps (e.g., steps 710-770) may be repeated for several iterations until the model is deemed to be sufficiently complete. As an example and not by way of limitation, the steps (e.g., steps 710-770) may be repeated for 30 iterations, where each iteration includes training the model to render an image based on a different camera viewpoint (e.g., each of 30 different camera viewpoints),

The method 700 may begin at step 710, where a computing system may access a particular image frame of a dynamic scene and depth information associated with the particular image frame. As discussed elsewhere herein, such an image frame along with depth information is also referred to as an RGB-D image. The dynamic scene may include one or more objects in motion. As an example and not by way of limitation, an object of the one or more objects in the dynamic scene may be a human in motion. Such a dynamic scene may be obtained from one or more sources including, for example, a video camera, a webcam, a prestored video upload on Internet, etc. The depth information may be used to generate a point cloud (e.g., point cloud 102) of the particular image frame.

At step 720, the computing system may generate a first latent representation (e.g., appearance code 120) based on the point cloud. The first latent representation may encode appearance information of the one or more objects depicted in the dynamic scene. For example, if an object in the dynamic scene is a human in motion, then the appearance information may include facial characteristics of the human, body characteristics of the human, cloth winkles, or details of clothes that the human is wearing. In particular embodiments, generating the first latent representation (e.g., appearance code 120) based on the point cloud may include obtaining a query pose (e.g., query pose 104) of the one or more objects depicted in the dynamic scene by fitting points from the point cloud onto a predetermined body model; extracting, using a sparse convolutional neural network (e.g., 3D backbone 106), 3D features from the query pose; generating a 3D volume (e.g., 3D feature volume 108) based on extracted 3D features; casting camera rays from a particular point of interest (e.g., query point 110) into the 3D volume to extract a subset of 3D features; and encoding, using a neural network, the subset of 3D features into the first latent representation (e.g., the appearance code 120).

At step 730, the computing system may access (1) a sequence of image frames (e.g., 10 RGB-D images) of the dynamic scene and (2) a set of key frames (e.g., 3 key frames). The sequence of image frames may include the one or more objects in motion at a particular time segment. For example, if the dynamic scene is a 2-minute video of a baby dancing, then the sequence of image frames may be representing a 10-second portion of the baby dancing in that video. In some embodiments, one of the image frames of the sequence of image frames may be the particular image frame that was used for generating the first latent representation (e.g., appearance code 120). The key frames may be used to complete missing information of the one or more objects in the sequence of image frames. For instance, the key frames may be used to complete missing information of the one or more objects when the dynamic scene is rendered from a first viewpoint that is different from a second viewpoint from which the sequence of image frames was captured.

Responsive to accessing the sequence of image frames and the set of key frames, the computing system may generate a sequence of query poses (e.g., query poses 122) corresponding to the sequence of image frames and a set of key poses (e.g., key poses 124) corresponding to the set of key frames. In particular embodiments, generating the sequence of query poses and the set of key poses may include accessing second depth information associated with each image frame of the sequence of image frames and the set of key frames; generating, using the second depth information, second point cloud associated with each image frame of the sequence of image frames and the set of key frames; accessing a predetermined body model or 3D mesh corresponding to the one or more objects; and obtaining the sequence of query poses and the set of key poses corresponding to the sequence of image frames and the set of key frames, respectively, by fitting points from the second point cloud associated with each image frame and each key frame onto the predetermined body model.

Once the sequence of query poses and the set of key poses are obtained, the computing system may then extract, using a sparse convolutional neural network (e.g., 3D backbone 128), 3D features from each of the sequence of query poses and the set of key poses; generate a set of 3D volumes (e.g., 3D feature volumes 130a, . . . , 130n) corresponding to the sequence of query poses and the set of key poses based on extracted 3D features from each of the sequence of query poses and the set of key poses; cast camera rays from a particular point of interest (e.g., query point 110) into each of the 3D volumes (e.g., 3D feature volumes 130) of the set to extract a subset of 3D features from the 3D volume; and perform point tracking to identify (1) a first correspondence between the point of interest and a same point across the query poses and key poses and (2) a second correspondence between the point of interest and other points in each of the query poses and key poses.

At step 740, the computing system may generate, using a temporal transformer (e.g., temporal transformer 132), a second latent representation (e.g., pose code 140) based on tracking and combining temporal relationship between the sequence of image frames and the set of key frames. The second latent representation may encode pose information of the one or more objects of the dynamic scene. In particular embodiments, generating, using the temporal transformer, the second latent representation may include combining the extracted subset of 3D features from each of the 3D volumes (e.g., 3D feature volumes 130), the first correspondence (e.g., between the point of interest and a same point across the query poses and key poses), and the second correspondence (e.g., between the point of interest and other points in each of the query poses and key poses); processing, using the temporal transformer, combined information; and encoding processed combined information into the second latent representation (e.g., pose code 140).

At step 750, the computing system may access camera parameters (e.g., camera parameters 150) for rendering the one or more objects of the dynamic scene from a desired novel viewpoint (e.g., query point 110). The camera parameters may include a spatial location and a viewing direction of the camera from which to render the one or more objects of the dynamic scene. In some embodiments, the particular image frame (e.g., RGB image) that is used for generating the first latent representation (e.g., appearance code 120) is captured from the desired novel viewpoint. The desired novel viewpoint may be provided via user input through one or more input mechanisms, such as, for example and without limitation, touch gesture, mouse cursor, mouse position, etc.

At step 760, the computing system may generate a third latent representation (e.g., view and spatial code 160) based on the camera parameters (e.g., camera parameters 150). The third latent representation may encode camera pose information for the rendering. In particular embodiments, each of the first latent representation (e.g., appearance code 120), the second latent representation (e.g., pose code 140), and the third latent representation (e.g., view and spatial code 160) may be generated using a neural network.

At step 770, the computing system may train or build an improved NeRF-based model for free-viewpoint rendering of the dynamic scene based on the first latent representation (e.g., appearance code 120), the second latent representation (e.g., pose code 140), and the third latent representation (e.g., view and spatial code 160). The improved NeRF-based model may be trained to perform the free-viewpoint rendering of the one or more objects in the dynamic scene under novel views (e.g., views different from a view associated with the input RGB-D image) and unseen poses (e.g., poses that are not seen during training). In particular embodiments, training or building the improved NeRF-based model may include generating, by the improved NeRF-based model, a color value and a density value, for each pixel, of an image to render; generating, by the improved NeRF-based model, the image based on combining color and density values of all pixels in the image; comparing generated image with a ground-truth image to compute a loss; and updating the improved NeRF-based model based on the loss. The ground-truth image and the image generated by the improved NeRF-based model may be associated with a same viewpoint, such as the desired novel viewpoint (e.g., query point 110).

Once the improved NeRF-based model is sufficiently trained (e.g., based on performing steps 710-770 for a several number of iterations), the computing system may perform the free-viewpoint rendering of a second dynamic scene using the trained improved NeRF-based model at inference time. The second dynamic scene may include a pose of the one or more objects that was not seen or observed during the training of the improved NeRF-based model. In particular embodiments, performing the free-viewpoint rendering of the second dynamic scene at the inference time may include (1) accessing a single image of the second dynamic scene, second depth information associated with the single image, a second desired novel viewpoint from which to render the second dynamic scene, and the set of key frames (e.g., 3 key frames); (2) generating the first latent representation (e.g., appearance code) based on the single image and the second depth information associated with the single image; (3) generating, using the temporal transformer, the second latent representation (e.g., pose code) based on the single image of the dynamic scene, the second depth information associated with the single image, and the set of key frames; (4) generating the third latent representation (e.g., view and spatial code) based on second camera parameters associated with the second desired novel viewpoint; and (5) generating, using the trained improved NeRF-based model, color and density values for pixels of an image to render from the second desired novel viewpoint.

Particular embodiments may repeat one or more steps of the method of FIG. 7, where appropriate. Although this disclosure describes and illustrates particular steps of the method of FIG. 7 as occurring in a particular order, this disclosure contemplates any suitable steps of the method of FIG. 7 occurring in any suitable order. Moreover, although this disclosure describes and illustrates an example method for training the improved NeRF-based model for novel view and unseen pose synthesis, including the particular steps of the method of FIG. 7, this disclosure contemplates any suitable method for training the improved NeRF-based model for novel view and unseen pose synthesis, including any suitable steps, which may include a subset of the steps of the method of FIG. 7, where appropriate. Furthermore, although this disclosure describes and illustrates particular components, devices, or systems carrying out particular steps of the method of FIG. 7, this disclosure contemplates any suitable combination of any suitable components, devices, or systems carrying out any suitable steps of the method of FIG. 7.

### Example Computer System

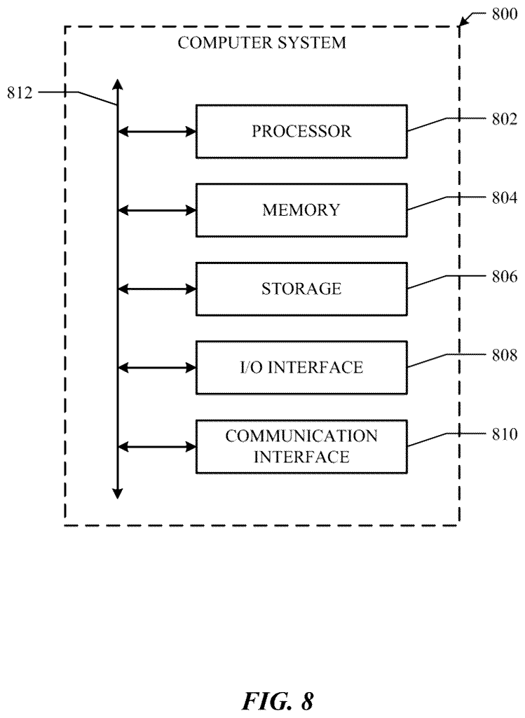

FIG. 8 illustrates an example computer system 800. In particular embodiments, one or more computer systems 800 perform one or more steps of one or more methods described or illustrated herein. In particular embodiments, one or more computer systems 800 provide functionality described or illustrated herein. In particular embodiments, software running on one or more computer systems 800 performs one or more steps of one or more methods described or illustrated herein or provides functionality described or illustrated herein. Particular embodiments include one or more portions of one or more computer systems 800. Herein, reference to a computer system may encompass a computing device, and vice versa, where appropriate. Moreover, reference to a computer system may encompass one or more computer systems, where appropriate.

This disclosure contemplates any suitable number of computer systems 800. This disclosure contemplates computer system 800 taking any suitable physical form. As example and not by way of limitation, computer system 800 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 800 may include one or more computer systems 800; be unitary or distributed; span multiple locations; span multiple machines; span multiple data centers; or reside in a cloud, which may include one or more cloud components in one or more networks. Where appropriate, one or more computer systems 800 may perform without substantial spatial or temporal limitation one or more steps of one or more methods described or illustrated herein. As an example and not by way of limitation, one or more computer systems 800 may perform in real time or in batch mode one or more steps of one or more methods described or illustrated herein. One or more computer systems 800 may perform at different times or at different locations one or more steps of one or more methods described or illustrated herein, where appropriate.

In particular embodiments, computer system 800 includes a processor 802, memory 804, storage 806, an input/output (I/O) interface 808, a communication interface 810, and a bus 812. Although this disclosure describes and illustrates a particular computer system having a particular number of particular components in a particular arrangement, this disclosure contemplates any suitable computer system having any suitable number of any suitable components in any suitable arrangement.

In particular embodiments, processor 802 includes hardware for executing instructions, such as those making up a computer program. As an example and not by way of limitation, to execute instructions, processor 802 may retrieve (or fetch) the instructions from an internal register, an internal cache, memory 804, or storage 806; decode and execute them; and then write one or more results to an internal register, an internal cache, memory 804, or storage 806. In particular embodiments, processor 802 may include one or more internal caches for data, instructions, or addresses. This disclosure contemplates processor 802 including any suitable number of any suitable internal caches, where appropriate. As an example and not by way of limitation, processor 802 may include one or more instruction caches, one or more data caches, and one or more translation lookaside buffers (TLBs). Instructions in the instruction caches may be copies of instructions in memory 804 or storage 806, and the instruction caches may speed up retrieval of those instructions by processor 802. Data in the data caches may be copies of data in memory 804 or storage 806 for instructions executing at processor 802 to operate on; the results of previous instructions executed at processor 802 for access by subsequent instructions executing at processor 802 or for writing to memory 804 or storage 806; or other suitable data. The data caches may speed up read or write operations by processor 802. The TLBs may speed up virtual-address translation for processor 802. In particular embodiments, processor 802 may include one or more internal registers for data, instructions, or addresses. This disclosure contemplates processor 802 including any suitable number of any suitable internal registers, where appropriate. Where appropriate, processor 802 may include one or more arithmetic logic units (ALUs); be a multi-core processor; or include one or more processors 802. Although this disclosure describes and illustrates a particular processor, this disclosure contemplates any suitable processor.

In particular embodiments, memory 804 includes main memory for storing instructions for processor 802 to execute or data for processor 802 to operate on. As an example and not by way of limitation, computer system 800 may load instructions from storage 806 or another source (such as, for example, another computer system 800) to memory 804. Processor 802 may then load the instructions from memory 804 to an internal register or internal cache. To execute the instructions, processor 802 may retrieve the instructions from the internal register or internal cache and decode them. During or after execution of the instructions, processor 802 may write one or more results (which may be intermediate or final results) to the internal register or internal cache. Processor 802 may then write one or more of those results to memory 804. In particular embodiments, processor 802 executes only instructions in one or more internal registers or internal caches or in memory 804 (as opposed to storage 806 or elsewhere) and operates only on data in one or more internal registers or internal caches or in memory 804 (as opposed to storage 806 or elsewhere). One or more memory buses (which may each include an address bus and a data bus) may couple processor 802 to memory 804. Bus 812 may include one or more memory buses, as described below. In particular embodiments, one or more memory management units (MMUs) reside between processor 802 and memory 804 and facilitate accesses to memory 804 requested by processor 802. In particular embodiments, memory 804 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 804 may include one or more memories 804, where appropriate. Although this disclosure describes and illustrates particular memory, this disclosure contemplates any suitable memory.

In particular embodiments, storage 806 includes mass storage for data or instructions. As an example and not by way of limitation, storage 806 may include a hard disk drive (HDD), a floppy disk drive, flash memory, an optical disc, a magneto-optical disc, magnetic tape, or a Universal Serial Bus (USB) drive or a combination of two or more of these. Storage 806 may include removable or non-removable (or fixed) media, where appropriate. Storage 806 may be internal or external to computer system 800, where appropriate. In particular embodiments, storage 806 is non-volatile, solid-state memory. In particular embodiments, storage 806 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 806 taking any suitable physical form. Storage 806 may include one or more storage control units facilitating communication between processor 802 and storage 806, where appropriate. Where appropriate, storage 806 may include one or more storages 806. Although this disclosure describes and illustrates particular storage, this disclosure contemplates any suitable storage.

In particular embodiments, I/O interface 808 includes hardware, software, or both, providing one or more interfaces for communication between computer system 800 and one or more I/O devices. Computer system 800 may include one or more of these I/O devices, where appropriate. One or more of these I/O devices may enable communication between a person and computer system 800. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 808 for them. Where appropriate, I/O interface 808 may include one or more device or software drivers enabling processor 802 to drive one or more of these I/O devices. I/O interface 808 may include one or more I/O interfaces 808, where appropriate. Although this disclosure describes and illustrates a particular I/O interface, this disclosure contemplates any suitable I/O interface.

In particular embodiments, communication interface 810 includes hardware, software, or both providing one or more interfaces for communication (such as, for example, packet-based communication) between computer system 800 and one or more other computer systems 800 or one or more networks. As an example and not by way of limitation, communication interface 810 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 810 for it. As an example and not by way of limitation, computer system 800 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 800 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 800 may include any suitable communication interface 810 for any of these networks, where appropriate. Communication interface 810 may include one or more communication interfaces 810, where appropriate. Although this disclosure describes and illustrates a particular communication interface, this disclosure contemplates any suitable communication interface.

In particular embodiments, bus 812 includes hardware, software, or both coupling components of computer system 800 to each other. As an example and not by way of limitation, bus 812 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 812 may include one or more buses 812, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method, implemented by a computing system, comprising:
accessing a particular image frame of a dynamic scene and depth information associated with the particular image frame, the dynamic scene comprising one or more objects in motion, wherein the depth information is used to generate a point cloud of the particular image frame;
generating a first latent representation based on the point cloud, the first latent representation encoding appearance information of the one or more objects depicted in the dynamic scene;
accessing (1) a sequence of image frames of the dynamic scene and (2) a set of key frames, wherein the sequence of image frames comprises the one or more objects in motion at a particular time segment, and wherein the key frames are used to complete missing information of the one or more objects in the sequence of image frames;
generating, using a temporal transformer, a second latent representation based on tracking and combining temporal relationship between the sequence of image frames and the set of key frames, wherein the second latent representation encodes pose information of the one or more objects;
accessing camera parameters for rendering the one or more objects from a desired novel viewpoint;
generating a third latent representation based on the camera parameters, the third latent representation encoding camera pose information for the rendering; and
training an improved neural radiance field (NeRF) based model for free-viewpoint rendering of the dynamic scene based on the first, second, and third latent representations.

2. The method of claim 1, wherein training the improved NeRF-based model comprises:
generating, by the improved NeRF-based model, a color value and a density value, for each pixel, of an image to render;
generating, by the improved NeRF-based model, the image based on combining color and density values of all pixels in the image;
comparing generated image with a ground-truth image to compute a loss; and
updating the improved NeRF-based model based on the loss.

3. The method of claim 2, wherein the ground-truth image and the image generated by the improved NeRF-based model are associated with a same viewpoint, the same viewpoint being the desired novel viewpoint.

4. The method of claim 1, wherein generating the first latent representation comprises:
obtaining a query pose of the one or more objects depicted in the dynamic scene by fitting points from the point cloud onto a predetermined body model;
extracting, using a sparse convolutional neural network, three-dimensional (3D) features from the query pose;
generating a 3D volume based on extracted 3D features;
casting camera rays from a particular point of interest into the 3D volume to extract a subset of 3D features; and
encoding, using a neural network, the subset of 3D features into the first latent representation.

5. The method of claim 1, further comprising:
accessing second depth information associated with each image frame of the sequence of image frames and the set of key frames;
generating, using the second depth information, second point cloud associated with each image frame of the sequence of image frames and the set of key frames;
accessing a predetermined body model or three-dimensional (3D) mesh corresponding to the one or more objects; and
obtaining a sequence of query poses and a set of key poses corresponding to the sequence of image frames and the set of key frames, respectively, by fitting points from the second point cloud associated with each image frame and each key frame onto the predetermined body model.

6. The method of claim 5, further comprising:
extracting, using a sparse convolutional neural network, 3D features from each of the sequence of query poses and the set of key poses;
generating a set of 3D volumes corresponding to the sequence of query poses and the set of key poses based on extracted 3D features from each of the sequence of query poses and the set of key poses;
casting camera rays from a particular point of interest into each of the 3D volumes of the set to extract a subset of 3D features from the 3D volume; and
performing point tracking to identify (1) a first correspondence between the point of interest and a same point across the query poses and key poses and (2) a second correspondence between the point of interest and other points in each of the query poses and key poses.

7. The method of claim 6, wherein generating, using the temporal transformer, the second latent representation comprises:
combining the extracted subset of 3D features from each of the 3D volumes, the first correspondence, and the second correspondence;
processing, using the temporal transformer, combined information; and
encoding processed combined information into the second latent representation.

8. The method of claim 1, further comprising performing the free-viewpoint rendering of a second dynamic scene using the improved NeRF-based model at inference time, wherein performing the free-viewpoint rendering of the second dynamic scene at the inference time comprises:
accessing a single image of the second dynamic scene, second depth information associated with the single image, a second desired novel viewpoint from which to render the second dynamic scene, and the set of key frames;
generating the first latent representation based on the single image and the second depth information associated with the single image;
generating, using the temporal transformer, the second latent representation based on the single image of the dynamic scene, the second depth information associated with the single image, and the set of key frames;
generating the third latent representation based on second camera parameters associated with the second desired novel viewpoint; and
generating, using the improved NeRF-based model, color and density values for pixels of an image to render from the second desired novel viewpoint.

9. The method of claim 8, wherein the second dynamic scene comprises a pose of the one or more objects that was not seen or observed during the training of the improved NeRF-based model.

10. The method of claim 1, wherein the improved NeRF-based model is trained to perform the free-viewpoint rendering of the one or more objects in the dynamic scene under novel views and unseen poses.

11. The method of claim 1, wherein the key frames are used to complete missing information of the one or more objects when the dynamic scene is rendered from a first viewpoint that is different from a second viewpoint from which the sequence of image frames was captured.

12. The method of claim 1, wherein an object of the one or more objects in the dynamic scene comprises a human in motion.

13. The method of claim 12, wherein the appearance information comprises one or more of facial characteristics of the human, body characteristics of the human, cloth winkles, or details of clothes that the human is wearing.

14. The method of claim 1, wherein the camera parameters comprise a spatial location and a viewing direction of the camera from which to render the one or more objects of the dynamic scene.

15. The method of claim 1, wherein the particular image frame that is used for generating the first latent representation is captured from the desired novel viewpoint.

16. The method of claim 1, wherein the desired novel viewpoint is provided via user input through one or more input mechanisms.

17. The method of claim 1, wherein one of the image frames of the sequence of image frames comprises the particular image frame that is used for generating the first latent representation.

18. The method of claim 1, wherein each of the first, second, and third latent representations is generated using a neural network.

19. One or more computer-readable non-transitory storage media embodying software that is operable when executed to:
access a particular image frame of a dynamic scene and depth information associated with the particular image frame, the dynamic scene comprising one or more objects in motion, wherein the depth information is used to generate point clouds of the particular image frame;
generate a first latent representation based on the point clouds, the first latent representation encoding appearance information of the one or more objects depicted in the dynamic scene;
access (1) a sequence of image frames of the dynamic scene and (2) a set of key frames, wherein the sequence of image frames comprises the one or more objects in motion at a particular time segment, and wherein the key frames are used to complete missing information of the one or more objects in the sequence of image frames;
generate, using a temporal transformer, a second latent representation based on tracking and combining temporal relationship between the sequence of image frames and the set of key frames, wherein the second latent representation encodes pose information of the one or more objects;
access camera parameters for rendering the one or more objects from a desired novel viewpoint;
generate a third latent representation based on the camera parameters, the third latent representation encoding camera pose information for the rendering; and
train an improved neural radiance fields (NeRF) based model for free-viewpoint rendering of the dynamic scene based on the first, second, and third latent representations.

20. A system comprising:
one or more processors; and
one or more computer-readable non-transitory storage media coupled to one or more of the processors and comprising instructions operable when executed by one or more of the processors to cause the system to:
access a particular image frame of a dynamic scene and depth information associated with the particular image frame, the dynamic scene comprising one or more objects in motion, wherein the depth information is used to generate point clouds of the particular image frame;
generate a first latent representation based on the point clouds, the first latent representation encoding appearance information of the one or more objects depicted in the dynamic scene;
access (1) a sequence of image frames of the dynamic scene and (2) a set of key frames, wherein the sequence of image frames comprises the one or more objects in motion at a particular time segment, and wherein the key frames are used to complete missing information of the one or more objects in the sequence of image frames;
generate, using a temporal transformer, a second latent representation based on tracking and combining temporal relationship between the sequence of image frames and the set of key frames, wherein the second latent representation encodes pose information of the one or more objects;
access camera parameters for rendering the one or more objects from a desired novel viewpoint;
generate a third latent representation based on the camera parameters, the third latent representation encoding camera pose information for the rendering; and
train an improved neural radiance fields (NeRF) based model for free-viewpoint rendering of the dynamic scene based on the first, second, and third latent representations.
